(19) United States
(12) Patent Application Publication
(10) Pub. No.: US 2008/0241356 A1
(43) Pub. Date: Oct. 2, 2008

(54) PHOTOVOLTAIC DEVICES MANUFACTURED USING CRYSTALLINE SILICON THIN FILMS ON GLASS

(76) Inventors: Jianming Fu, Palo Alto, CA (US); Zheng Xu, Pleasanton, CA (US)

Correspondence Address: GLENN PATENT GROUP, 3475 EDISON WAY, SUITE L, MENLO PARK, CA, 94025, US

(21) Appl. No.: 11/766,979

(22) Filed: Jun. 22, 2007

Related U.S. Application Data
(63) Continuation-in-part of application No. 11/695,495, filed on Apr. 2, 2007.

(51) Int. Cl. B05D 5/12

(52) U.S. Cl. 427/74

(57) ABSTRACT

A method for fabricating an array of interconnected photovoltaic cells on a single substrate is disclosed. A silicon nitride (SiNx) layer is deposited onto a glass substrate for use as both a diffusion barrier and as an anti-reflection coating (ARC); an n⁺ Si layer is deposited as a front electrode and as a wetting layer for subsequent coating with a crystalline Si layer by liquid phase deposition (LPD); a first laser scribing is performed to separate the n⁺ Si layer into stripes; stripes of crystalline Si are deposited onto the first n⁺ Si layer, with a small offset, wherein each stripe of crystalline Si covers a majority of one stripe of n⁺ layer underneath, and also covers an edge portion of a neighboring stripe of n⁺ layer; a p⁺ a-Si layer is deposited; an Al layer is deposited for use as both an electrode and as a back-reflector; and the Al and p⁺ Si layers are divided into stripes to form spaced, isolated solar cells. In this way, a p-i-n photovoltaic cell is formed for each stripe of said device in which the photovoltaic cells are series connected.

### CROSS REFERENCE TO RELATED APPLICATIONS

This application is a continuation-in-part of U.S. patent application Ser. No. 11/695,495, filed Apr. 2, 2007, which application is incorporated herein in its entirety by this reference thereto.

### BACKGROUND OF THE INVENTION

1. Technical Field

The invention relates to photovoltaic devices. More particularly, the invention relates to photovoltaic devices that are manufactured using crystalline Silicon thin films on glass substrates.

2. Description of the Prior Art

Rising fuel costs and increasing worldwide energy demands have created a need for alternatives to conventional, e.g. hydrocarbon-based, sources of energy. Solar generated electricity is becoming a practical solution that addresses the increasing energy demand and may eventually replace the conventional hydrocarbon fueled power plant. Currently, solar electricity only accounts for 1.5% of the 5000 GW electricity market. The total available market for solar cells reached $4B in 2005 and is increasing rapidly, with a CAGR of 25-30% for the next ten years.

A simple solar cell consists of two layers of semiconductor material, typically silicon, sandwiched together between metal contacts. One layer, of n-type material, contains negatively charged free electrons; the other layer, of p-type material, contains positively charged “holes,” which are empty electron states in the valence band of semiconductors. At the junction where the two layers meet, electrons from the n-type region diffuse into the p-type region, and vice versa for holes the p-type region. The electrons that diffuse from n-type region leave behind positive charge centers, and holes from p-type regions leave behind negative charge centers. These charges establish an electric field preventing further diffusion of electrons and holes, until equilibrium is reached. When light of an appropriate wavelength strikes the solar cell, the individual packets of energy, called photons, excite the electrons to the conduction band, leaving a hole in valence band, simultaneously creating an electron-hole pairs. The electric field then coaxes these free electrons and holes to move in opposite directions. The result is a build-up of free electrons in the n-type material, and a build up of holes, i.e. a shortage of electrons, in the p-type material. An external circuit provides a path for the electrons to return to the p-type material, producing an electric current along the way that continues as long as light strikes the solar cell.

Solar cells in accordance with the prior art are presently produced by either of two known methods:

For the first generation, the solar cells were formed on poly or single crystal silicon wafers that are 150 um-250 um thick. For each MW electricity output, 14.78 tons of silicon is needed because of losses that result from the manufacturing process. The recent supply shortage and price hiking of silicon feedstock also creates a hurdle to the growth of the solar cell industry. Efforts have been made to increase the utilization, such as with string ribbon and EFG, but the films are still rather thick.

For the second generation, the solar cells are formed using thin films on substrates. Compound semiconductors, such as CdTe and CIGS thin films, have been investigated as alternative to silicon and demonstrate reasonable conversion efficiency. However, the technology maturity, the toxicity of the materials used to manufacture such cells, and the limited availability of materials used to manufacture such cells, such as indium, tellurium, and selenium, are casting a shadow on the future of these types of solar cell.

Amorphous silicon thin film is also used to manufacture solar cells on substrates. However, the energy conversion efficiency of such cells is low (˜5-8%) due to low carrier mobility in amorphous silicon and the thin film thickness. The film has to be thin for photon generated carriers to reach the collecting electrodes due to low carrier lifetime and mobility. The thin a-silicon film cannot absorb the solar energy effectively due to low absorption coefficient and band gap mismatch with solar spectrum. Usually this type of cell has a high open-circuit voltage (Voc), but a low short-circuit current (Jsc) and fill factor (FF). The energy conversion efficiency of such cell also degrades as the level of hydrogen within the film decreases.

It is thought that 50-100 um thick silicon films are the best for high efficiency solar cell manufacturing. However, it is difficult to handle this material in the form of stand-alone wafers. On the other hand, there is no effective method for producing 50-100 um thin film solar cells at a production-worthy rate.

Noboru Tsuya has described a method for growing thin silicon ribbons in U.S. Pat. No. 4,682,206. In the '206 patent, the molten silicon is ejected through thin nozzles onto a surface having a temperature that is below 400° C., thus forming a flexible silicon ribbon that is separated from the substrate. The cooling rate is super fast to obtain small grains of between 5 um and 200 um for flexibility.

Phillippe Knauth et al describe a sheet drawing process from melt in U.S. Pat. No. 5,298,109. A melt of silicon is crystallized on a moving substrate. However, the films formed in this method are rather thick, on the order of 0.5 mm.

In the prior art, solar cells are mounted onto solar glass by SOLAR EVA®, which is the trade name of ethylene-vinyl acetate (EVA) encapsulating materials for solar modules made by Hi-Sheet Industries, Ltd. This step is typically followed by an inter-cell connection (see, for example, W. Mulligan, D. Rose, M. Cudzinovic, D. DeCeuster, K. McIntosh, D. Smith, R. Swanson, Manufacturing of Solar Cells with 21% Efficiency, SunPower Corporation). Thus, interconnection of the cells is accomplished by additional steps, including the provision of solder pads and soldering of ribbons to the pads, sometimes with bending from the backside to the front side of the substrate. This increases cost and also may result in reliability problems due to thermal mismatches.

A major advantage of thin film Si photovoltaic devices over conventional wafer based modules is that the manufacturing cost per unit area can be greatly reduced. In addition to using much less silicon, such devices are also manufactured on large area substrates, such as stainless steel or glass, thus lowering the manufacturing cost by scaling. However, solar cells that use amorphous or microcrystalline Si thin film suffer from lower photo energy conversion efficiency than wafer based polycrystalline Si solar cells. This limits the application of such devices in the photovoltaic market.

U.S. patent application Ser. No. 11/695,495 describes a method for preparing thin crystalline silicon thin films on glass substrates and general ways of using this thin film to manufacture photovoltaic devices. With the invention disclosed herein, the inventors teach unique methods for manufacturing such devices.

### SUMMARY OF THE INVENTION

The invention provides a method for fabricating an array of interconnected photovoltaic cells on a single substrate. In a presently preferred embodiment of the invention, a SiNx layer is deposited onto a glass substrate for use as both a diffusion barrier and as an anti-reflection coating (ARC); an n⁺ Si layer is deposited as a front electrode and as a wetting layer for subsequent coating with a crystalline Si layer by liquid phase deposition (LPD); a first laser scribing is performed to separate the n⁺ Si layer into stripes; stripes of crystalline Si are deposited onto the first n⁺ Si layer, with a small offset, wherein each stripe of crystalline Si covers a majority of one stripe of n⁺ layer underneath, and also covers an edge portion of a neighboring stripe of n⁺ layer; a p⁺ a-Si layer is deposited; an Al layer is deposited for use as both an electrode and as a back-reflector; and the Al and p⁺ Si layers are divided into stripes to form spaced, isolated solar cells. In this way, a p-i-n photovoltaic cell is formed for each stripe of said device in which the photovoltaic cells are series connected.

### BRIEF DESCRIPTION OF THE DRAWINGS

FIG. 1 is a cross section of a photovoltaic device structure having series connected cells according to the invention;

FIG. 2 is a cross section of a photovoltaic device showing a current flow between connected cells according to the invention;

FIG. 3 is a cross section of a photovoltaic device showing a second laser scribe to open a trench that extends through the Si layer to the glass substrate according to the invention; and

FIG. 4 is a cross section of a photovoltaic device showing a patterned Mo layer according to the invention.

### DETAILED DESCRIPTION OF THE INVENTION

The invention disclosed herein teaches unique methods for manufacturing thin crystalline silicon thin films on glass substrates.

Large area amorphous Si thin film devices have been manufactured using low-cost manufacturing methods. A typical method involves three laser scribing steps, where the first scribing step separates the TCO electrodes, the second scribing step separates the Si absorbing layer and creates an opening to the front electrode, and the third scribing step separates the back electrodes.

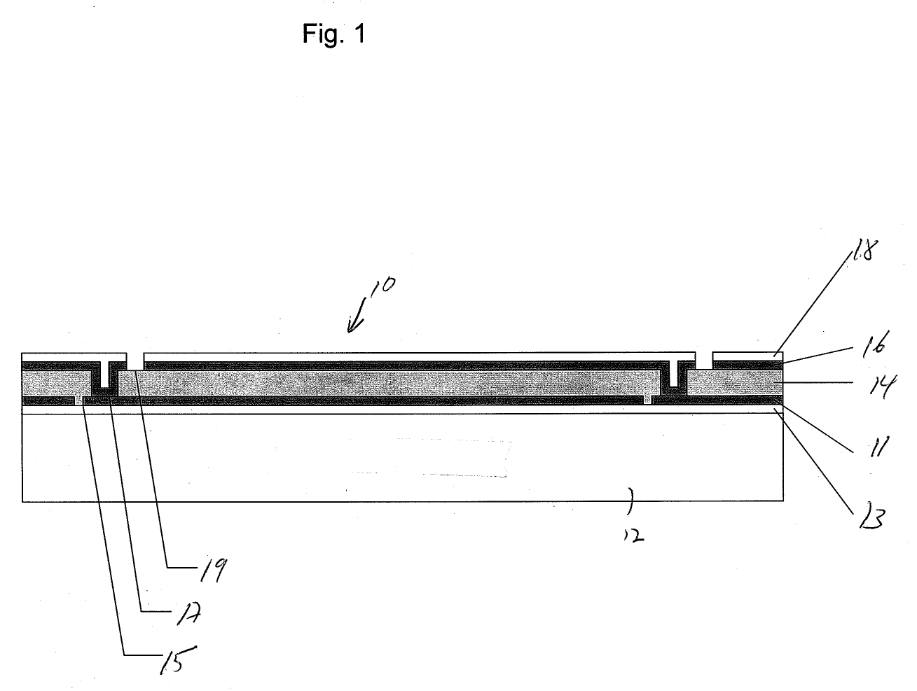

FIG. 1 is a cross section of a photovoltaic device structure having series connected cells according to the invention. In the device 10, a thick n⁺ layer 11 is used as a front electrode. The thickness could be between 100 nm and 1000 nm, preferably between 200 nm and 500 nm. On a glass substrate 12, a SiNx layer 13, or a SiNx/SiO2 stack, is first deposited as a diffusion barrier and anti-reflection coating (ARC). Then a layer of n⁺ Si 11 is deposited as the front electrode and as a wetting layer for subsequent coating with a crystalline Si layer by liquid phase deposition (LPD). The alternative to this layer is an n+/intrinsic (i) Si stack. The intrinsic Si layer thickness could be between 100 nm and 1000 nm, but preferably between 100 nm and 300 nm. These layers could be deposited by using PECVD process, deposited in-situ. Thus it ensures a high quality n⁺-intrinsic interface.

A first laser scribing 15 separates the n⁺ Si (or n⁺/i) layer into stripes. Then stripes of crystalline Si 14 are deposited onto the first n⁺ Si layer, with a small offset as low as 25 micron, as shown in FIG. 1. The crystalline Si can be either intrinsic or slightly p-type doped. Each stripe of crystalline Si should cover a majority of one stripe of the n⁺ layer that is underneath it, but it should also cover an edge portion 17 of the neighboring stripe of the n⁺ layer. A p⁺ a-Si layer 16 is then deposited globally onto the substrate, followed by deposition of an Al layer 18, which is used as both an electrode and as a back-reflector. At a next step, any of multiple methods can be used to divide the Al and p⁺ Si layers into stripes to form the isolated solar cells, e.g. forming a back electrode separation line 19 using a wet etch technique. Thus, a p-i-n solar cell is formed for each stripe of the structure.

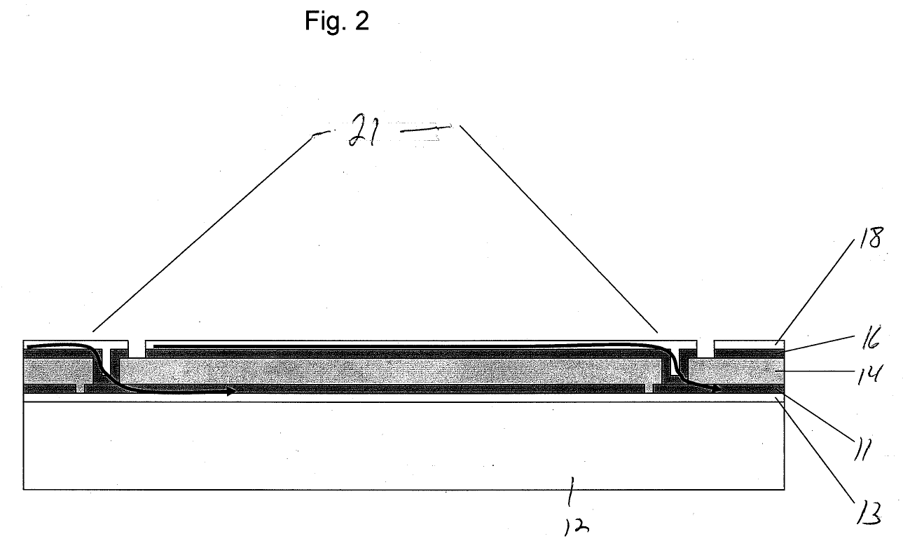

An important aspect of this process is that the spaces between the crystalline Si stripes also comprise openings for the formation of a front contact. FIG. 2 is a cross section of a photovoltaic device showing a current flow between connected cells according to the invention. The p+ layer and subsequent Al layer deposition form an Ohmic contact to the exposed n⁺ Si layer. Thus, the back contact for one cell is connected to the front electrode of the next cell. Because each cell generates several hundred millivolts, the series connected cells form a part of a module that produces a total of 30-100 volts. The resulting current flow 21 is illustrated in FIG. 2.

In one preferred embodiment of the invention, separation of the back electrodes is achieved by first laser scribing the Al layer. Then the Al layer is used as a hard mask, and the Si layer is etched by use of chemicals or a plasma. This approach exhibits good selectivity of Si over Al, i.e. the etch rate of Si is much faster than that of Al. Etching of Si can be stopped at the p⁺ Si/crystalline Si interface, or it can proceed further into the crystalline Si, as long as a good electrical isolation is achieved.

In another embodiment of the invention, separation of the back electrodes is accomplished by laser scribing into the Si layer. In this embodiment, the laser pulse energy, pulse rate, and laser scanning rate are adjusted to drive the separation trench deeper, not only through the Al layer, but further through the p⁺ Si layer.

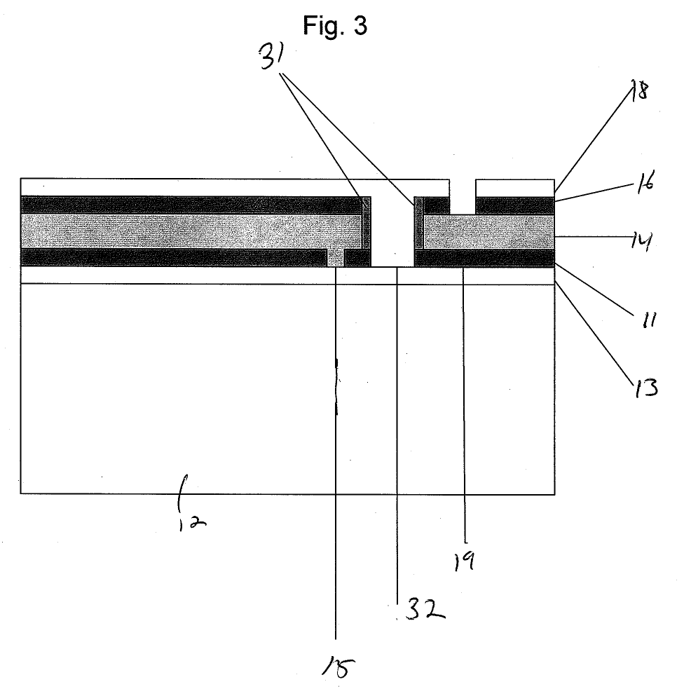

In yet another embodiment of the invention, the crystalline Si layer is deposited globally onto the substrate, followed by deposition of the p⁺ amorphous Si layer. FIG. 3 is a cross section of a photovoltaic device showing a second laser scribe 32 to open a trench that extends through the Si layer to the glass substrate according to the invention. During the laser scribing process, the Si layer is re-melted and the trench wall is doped with an n-type dopant 31. The n⁺ layer can be heavily doped to a dopant concentration that is over 10²⁰ atoms/cm³. This approach not only provides isolation of the trench from the crystalline Si region, but it also provides a surface for contact to the n region. A subsequent Al deposition forms the metal contacts for the front electrodes. Separation of the back electrodes is accomplished by the same method as described above.

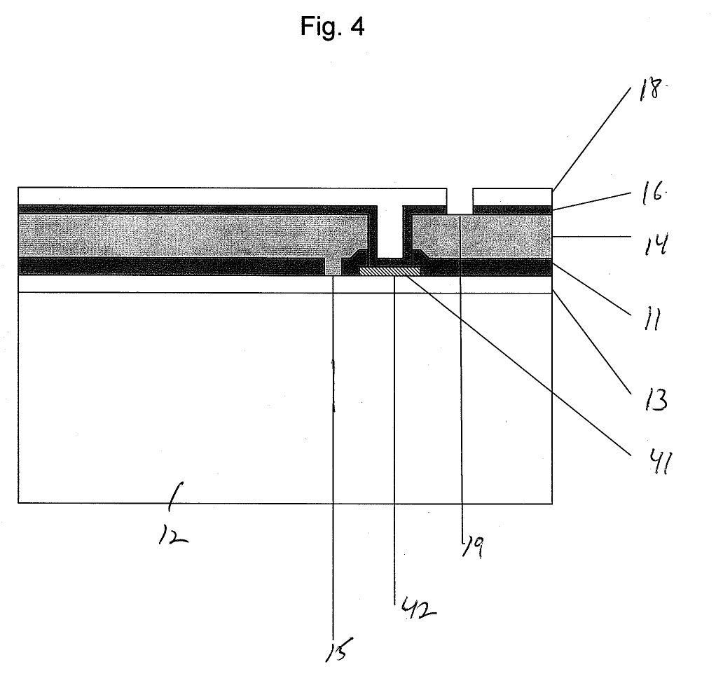

FIG. 4 shows another alternative for the device processes. After ARC deposition, a layer of molybdenum (Mo) 41 around 100 nm is deposited onto the substrates. The Mo layer is then patterned into stripes of 50 μm-200 μm wide. This is followed by deposition of n⁺ or n⁺/i Si layer. The Si layer is then scribed by laser, right beside one edge of the Mo stripes. Subsequently, the LPD Si layer is deposited. During this process, some Mo forms silicide with Si. MoSi₂ has a low resistivity around 60 micro-ohm/cm. Thus, a good ohmic contact is formed between the Si and Mo, including the n⁺ layer for the cell on the right hand side. It is expected that some Mo remaining is not reacted. The Si layer is then covered with a mask of either photoresist or other materials, such as oxide, with an opening right above the Mo stripes. Then it is etched 42 by etchants such as KOH, which preferably etch the Si but that do not etch the Mo. The etching stops either on MoSiₓ or Mo. Finally p⁺ and Al are deposited onto the entire substrate, followed by the last separation of back electrode as described earlier. The highly doped p+ layer forms low resistance contact with MoSi₂/Mo layers underneath. Through these processes, low-resistance front and back electrodes, as well as the inter-cell connections, are achieved.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A method for fabricating an array of interconnected photovoltaic cells on a single substrate, comprising the steps of:
depositing a SiNx (silicon nitride) layer onto a glass substrate for use as both a diffusion barrier and as an anti-reflection coating (ARC);
depositing an n⁺ Si layer or n⁺/intrinsic Si layers as a front electrode and as a wetting layer for subsequent coating with a crystalline Si layer by liquid phase deposition (LPD);
performing a first laser scribing to separate the n⁺ Si layer into stripes;
depositing stripes of crystalline Si onto the first n⁺ Si layer, or n⁺/intrinsic Si layers, with a small offset, wherein each stripe of crystalline Si covers a majority of one stripe of n⁺ layer or n⁺/intrinsic Si layers underneath, and also covers an edge portion of a neighboring stripe of n⁺ layer;
depositing a p⁺ a-Si layer;
depositing an Al layer for use as both an electrode and as a back-reflector; and
dividing the Al and p⁺ Si layers into stripes to form spaced, isolated solar cells;
wherein a p-i-n photovoltaic cell is formed for each stripe of said device; and
wherein said photovoltaic cells are series connected.

2. The method of claim 1, further comprising the step of:
doping the crystalline Si layer with slightly p-type dopant, or leaving it undoped, remaining intrinsic.

3. The method of claim 1, said dividing step further comprising the step of:
using a wet etch technique to form a back electrode separation line.

4. The method of claim 1, wherein spaces between the crystalline Si stripes further comprise openings for formation of a front contact.

5. The method of claim 1, further comprising the step of:
forming an Ohmic contact with said p⁺ layer and Al layer to an exposed n⁺ Si layer;
wherein a back contact for one cell is connected in series to a front electrode of a next cell.

6. The method of claim 1, wherein said dividing step further comprises the steps of:
laser scribing the Al layer;
using the Al layer as a hard mask; and
etching the Si layer with any of chemicals or a plasma.

7. The method of claim 6, further comprising the step of:
either stopping said etching step at a p⁺ Si/crystalline Si interface, or allowing said etching step to proceed further into the crystalline Si layer.

8. The method of claim 1, wherein said dividing step further comprises the steps of:
laser scribing into the Si layer;
wherein laser pulse energy, pulse rate, and laser scanning rate are adjusted to drive a separation trench deeper, not only through the Al layer, but further through the p⁺ Si layer.

9. The method of claim 1, wherein said crystalline Si layer is first deposited globally onto the substrate, followed by deposition of the p⁺ amorphous Si layer.

10. The method of claim 1, further comprising the step of:
performing a second laser scribe to open a trench that extends through the Si layer to the glass substrate.

11. The method of claim 10, wherein during the second laser scribe, the SI layer is re-melted and the trench wall is covered with an n-type Si layer.

12. The method of claim 11, further comprising the step of:
doping said n⁺ layer to a dopant concentration that is over 10²⁰ atoms/cm³.

13. The method of claim 11, further comprising the step of:
performing a subsequent Al deposition to form metal contacts to front electrodes.

14. A method for fabricating an array of interconnected photovoltaic cells on a single substrate, comprising the steps of:
depositing a SiNx (silicon nitride) layer onto a glass substrate for use, as both a diffusion barrier and as an anti-reflection coating (ARC);
depositing a Molybenum (Mo) layer onto said substrate;
patterning said Mo layer into stripes 50-200 uM wide;
depositing an n⁺ Si layer or n⁺/intrinsic Si layers as a front electrode and as a wetting layer for subsequent coating with a crystalline Si layer by liquid phase deposition (LPD);
performing a first laser scribing to separate the n⁺ Si layer into stripes beside an edge of said Mo stripes;
depositing stripes of crystalline Si onto the first n⁺ Si layer, or n⁺/intrinsic Si layers, with a small offset, wherein each stripe of crystalline Si covers a majority of one stripe of n⁺ layer or n⁺/intrinsic Si layers underneath, and also covers an edge portion of a neighboring stripe of n⁺ layer;
masking said Si layer with an opening above said Mo stripes;
etching said Si layer but not said Mo layer;
depositing a p⁺ a-Si layer;
depositing an Al layer for use as both an electrode and as a back-reflector; and
dividing the Al and p⁺ Si layers into stripes to form spaced, isolated solar cells;
wherein a p-i-n photovoltaic cell is formed for each stripe of said device; and
wherein said photovoltaic cells are series connected.

15. The method of claim 14, further comprising the step of:
doping the crystalline Si layer with slightly p-type dopant, or leaving it undoped, remaining intrinsic.

16. The method of claim 14, said dividing step further comprising the step of:
using a wet etch technique to form a back electrode separation line.

17. The method of claim 14, wherein spaces between the crystalline Si stripes further comprise openings for formation of a front contact.

18. The method of claim 14, further comprising the step of:
forming an Ohmic contact with said p+ layer and Al layer to an exposed n⁺ Si layer;
wherein a back contact for one cell is connected in series to a front electrode of a next cell.

19. The method of claim 14, wherein said dividing step further comprises the steps of:
laser scribing the Al layer;
using the Al layer as a hard mask; and
etching the Si layer with any of chemicals or a plasma.

20. The method of claim 19, further comprising the step of:
either stopping said etching step at a p⁺ Si/crystalline Si interface, or allowing said etching step to proceed further into the crystalline Si layer.

21. The method of claim 14, wherein said dividing step further comprises the steps of:
laser scribing into the Si layer;
wherein laser pulse energy, pulse rate, and laser scanning rate are adjusted to drive a separation trench deeper, not only through the Al layer, but further through the p⁺ Si layer.

22. The method of claim 14, wherein said crystalline Si layer is first deposited globally onto the substrate, followed by deposition of the p⁺ amorphous Si layer.

23. The method of claim 14, further comprising the step of:
performing a second laser scribe to open a trench that extends through the Si layer to the glass substrate.

24. The method of claim 23, wherein during the second laser scribe, the Si layer is re-melted and the trench wall is covered with an n-type Si layer.

25. The method of claim 24, further comprising the step of:
doping said n⁺ layer to a dopant concentration that is over 10²⁰ atoms/cm³.

26. The method of claim 25, further comprising the step of:
performing a subsequent Al deposition to form metal contacts to front electrodes.
